(19) United States
(12) Patent Application Publication
(10) Pub. No.: US 2008/0052099 A1
(43) Pub. Date: Feb. 28, 2008

(54) ENTERTAINMENT DIVERSION DURING REAL ESTATE REVIEW

(76) Inventor: David PALIK, Broken Arrow, OK (US)

Correspondence Address: WINSTON & STRAWN LLP;PATENT DEPARTMENT, 1700 K STREET, N.W., WASHINGTON, DC, 20006, US

(21) Appl. No.: 11/781,027

(22) Filed: Jul. 20, 2007

Related U.S. Application Data
(60) Provisional application No. 60/839,690, filed on Aug. 24, 2006.

(51) Int. Cl. G06Q 99/00

(52) U.S. Cl. 705/1

(57) ABSTRACT

A method of enhancing personal reviews of available real estate which includes providing a vehicle that includes individually selectable entertainment for passengers in the vehicle. This provides a pleasant diversion during travel between real estate locations to facilitate such reviews and enhance the personal real estate review experience.

This application claims the benefit of application No. 60/839,690 filed Aug. 24, 2006, the entire content of which is expressly incorporated herein by reference thereto.

### TECHNICAL FIELD

The present invention concerns a method for managing and facilitating the sale of real estate. More particularly, the invention relates to enhancing personal review of available real estates by providing a diversion, preferably an entertainment diversion, during travel between real estate locations to facilitate such reviews.

### BACKGROUND OF THE INVENTION

One of the most important decisions in a family's life is the purchase of a home. Often this process leads to decision making involving the whole family, with the parents providing guidance on the practical and financial aspects which make such venture feasible. Generally, a real estate agent takes the entire family on a tour of available real estates in the neighborhood of interest. This process can become lengthy and quite boring for the younger member(s) of the family which can lead to distraction for the parents, and thereby preventing the parents from concentrating on this very important endeavor. The process of purchasing a home can therefore be strenuous for the parents and boring for the children.

Although the real estate industry may very well be aware of the rather arduous process that buyers experience during home selection, yet it has failed to adequately address the human aspect of their business. The real estate industry for many decades has focused its attention exclusively on the utilitarian aspects of the business and transaction. The industry has developed methods and systems to increase the efficiency of contracts of sale and advertisement of properties that are listed for sale, and have sorted through the issues that stem thereof.

One system known for assisting the buying and selling of properties is disclosed in U.S. Pat. No. 7,016,866 which teaches a point of contact for sellers, buyers, negotiators and third party service providers in the real estate market, offering a forum for identifying needs, presenting solutions and accessing a suite of real estate tools and services. The application architecture includes resource applications enabling users to access real estate information and tools; transaction applications enabling users to register, submit preference information, provide property information (regarding properties to sell or to buy), and apply for loans; appointment management applications enabling users to request, confirm and cancel appointments; advertising applications enabling market players to advertise real estate-related offerings to users; and operations applications for managing the operation of the system.

U.S. Pat. No. 5,867,155 teaches a network system that provides video information on demand concerning real estate properties, and in principle includes a large number of real estate information server locations as viewing sites. The servers are interconnected by a dedicated hard wire network so that video information may be shared. The video information is recorded, stored, transferred, and displayed using high speed digital data handling techniques. The video information is accompanied by digitized audio sound tracks.

Another video on demand service is know from U. S. Patent Application No. 2006/0015925 which teaches a system for replaying a sales presentation television program using a video on demand (VOD) or digital video recording (DVR) system. For example, a real estate presentation can be viewed which limits the segments played back to those relating to properties in a particular price range, with a particular number of bedrooms, or in a particular location. Playlists for product can be devoted to particular price ranges, to products of interest to a particular gender or age group, or in a particular category.

The aforementioned can assist potential home buyers by allowing them to minimize the number of houses selected for actual site visit. However, buyers will not commit to the single most expensive purchase of their life without reviewing their potential future home. Therefore, there remains a need to improve in the way the potential buyers interface the real estate professionals within the realm of a vehicle during travel between real estate locations.

### SUMMARY OF THE INVENTION

The present invention relates to a method of enhancing personal reviews of available real estate by providing a vehicle that includes individually selectable entertainment for passengers in the vehicle. This provides a pleasant diversion during travel between real estate locations to facilitate such reviews and enhance the personal real estate review experience.

Advantageously, the individually selectable entertainment is provided at each passenger seat in the vehicle so that each passenger can select their personal preference for the form of entertainment to be reviewed. Preferably, the individually selectable entertainment is in the form of electronic entertainment, including one or more of a computer, a portable music player, or a video monitor for use by vehicle passengers.

To accomplish this, the method further comprises providing at least one computer in the vehicle and preferably one for each vehicle passenger. At least one computer in the vehicle includes a database stored on a storage device of the computer to provide information on available real estate properties, while the same computer or at least one other computer in the vehicle includes a database stored on a storage device of the computer to provide forms related to real estate sales for completion by customer during travel.

The method further comprises providing a wireless connection for at least one computer to the Internet network to facilitate sale of a product, such as songs and movies, or to facilitate e-mail service for review by a vehicle passenger during travel.

Other forms of entertainment provided by the method include providing at least one portable music player (e.g., an iPod), video monitor or device that provides radio broadcast service in the vehicle and preferably one for each vehicle passenger. When a monitor is present, it is operatively associated with a computer or video broadcast to provide movies or television broadcast services. One or more monitors may also provide the capability for playing video games and in that case the method further comprises providing video game controllers and related equipment for playing such games.

The method preferably further comprises providing GPS capability to the vehicle to optimize travel between real estate locations. This can be programmed into the computer prior to leaving the sales office or it can be programmed on the fly as additional properties are selected for a personal review.

### BRIEF DESCRIPTION OF THE DRAWINGS

FIG. 1 is a exterior view of an embodiment of a vehicle configured according to the present invention;

FIG. 2 is a depiction of an embodiment of individually selectable entertainment for each passenger in the vehicle configured according to the present invention;

FIG. 3 is a view of an embodiment of displays in the vehicle configured according to the present invention;

FIG. 4 is a view of an embodiment of a computer in the vehicle configured according to the present invention; and

FIG. 5 is a view of an embodiment of a wiring diagram in the vehicle according to the present invention.

### DETAILED DESCRIPTION OF THE PREFERRED EMBODIMENTS

The following description is presented to enable any person of ordinary skill in the art to make and practice the present invention. Modifications to the preferred embodiment will be readily apparent to those of ordinary skill in the art, and the disclosure set forth herein may be applied to other embodiments and applications without departing from the spirit and scope of the present invention and the appended claims. Thus, the present invention is not intended to be limited to the embodiments described, but is to be accorded the broadest scope consistent with the claims appended hereto and the disclosure set forth herein.

There has been a significant disparity between what Realtors offer the public in terms of utilitarian service and what the public desires. The majority of potential buyers are very entertainment oriented and expect more that just transaction expertise from the real estate professional. The home buying journey is currently a mundane process for most potential buyers. Most potential buyers, although excited at first, quickly become frustrated over the drudgery of the home buying journey. This is particularly true for families.

One objective of the present invention is to change the completion of real estate transactions by creating a sustainable competitive advantage through providing four things to the public Entertainment, Value, Service and Fun (EVST). Another objective is to provide consistently outstanding service to the public through the standardization of all of the processes involved in the real estate journey. Third objective is to develop a turnkey business model that governs every facet of the real estate journey. The business model can then be deployed in any market that is deemed to be viable and assure that a high quality journey will be imparted. The real estate industry has never adequately addressed the lifestyle needs such as, preferences, tastes, and desires of the public.

Generally, a real estate professional and potential purchaser of a property select a number of properties meeting the purchaser's requirements, and then drive together to several properties, often taking a great deal of time. Frequently, due to inadequate description by the purchaser or to misinterpretation by the agent, the process of selecting a property can become very frustrating for the buyer. Furthermore, many potential purchasers, upon visiting the properties in the price range or otherwise satisfying the criteria that they have specified to the real estate agent, alter their requirements, necessitating still further drive in a vehicle for the review of further available properties. This process can be very demanding on the potential buyer and any method to reduce this demand, even temporarily, will lessen the burden on the buyer and provide a more positive experience. The present invention facilitates enhancing the experience of looking for property by providing in-vehicle entertainment to the potential buyer and accompanied family members during such endeavor.

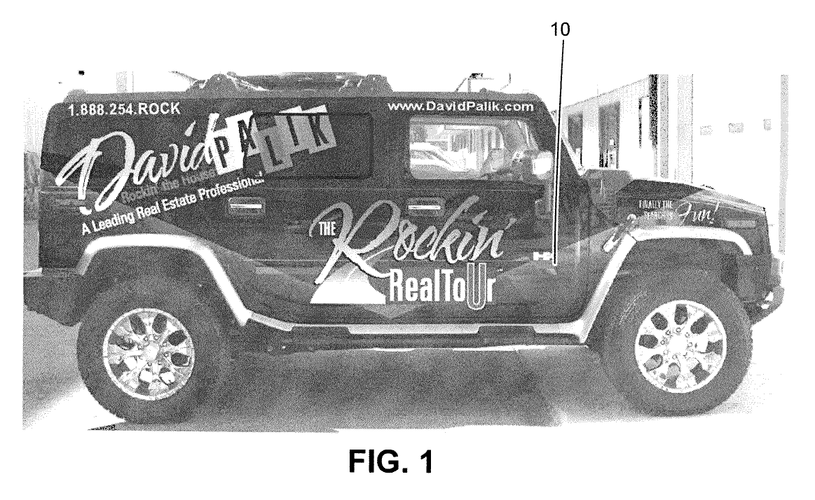

Referring to FIG. 1, a preferred embodiment of a vehicle exterior 10 employed to drive the agent and the potential buyer and family during the review of available real estates. The vehicle exterior 10 is configured to project a unique approach to public interface, where the human experience of purchasing a house is of high priority. Moreover, such a projection can bring about an expectation on the part of the potential buyer which when appropriately channeled facilitates an engaging experience for all passengers. Illustratively, prior to review of available real estates, a survey form can be provided to all passengers requesting from them food, entertainment, and game preferences. During the review, the requested items are provided to the passengers to help engage their attention individually on items of interest.

Preferably, the vehicle 10 is a General Motors “H2” HUMMER with imprints that can include an agent's name, phone number, web site, e-mail address, company name, and logo. One logo, for example, can be “The Rockin RealToUr^{SM}”. Of course, other vehicles can be used if desired. Any type of automobile, van or SUV may be provided with the invention but those that provide greater passenger comforts are of course preferred.

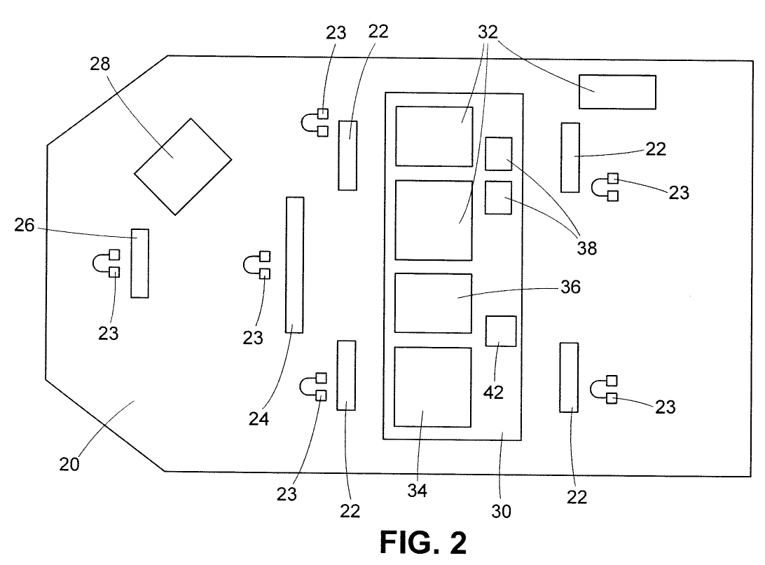

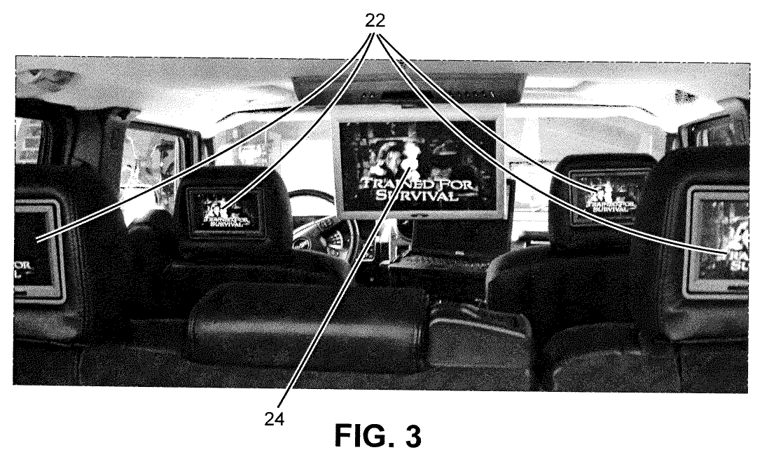

In the embodiment shown in FIGS. 2 and 3, the vehicle interior 20 includes a headrest display unit 22 that can provide a passenger with an individual display. Preferably, the vehicle includes four headrest displays with each headrest display 22 having a built-in DVD player, and a separate input control that permits choice of programs for the passengers. For example, one passenger can be viewing a satellite TV program, while another passenger can be viewing a DVD (Movie), and yet another passenger can be playing a video game. Each headrest display unit 22 preferably includes a wireless headset 23 which allows viewers to listen to an audio portion of a program associated with any display units within the vehicle. Preferably, the headrest display 22 is of the type described in U.S. Pat. No. 7,040,698, the content of which is expressly incorporated herein by reference thereto.

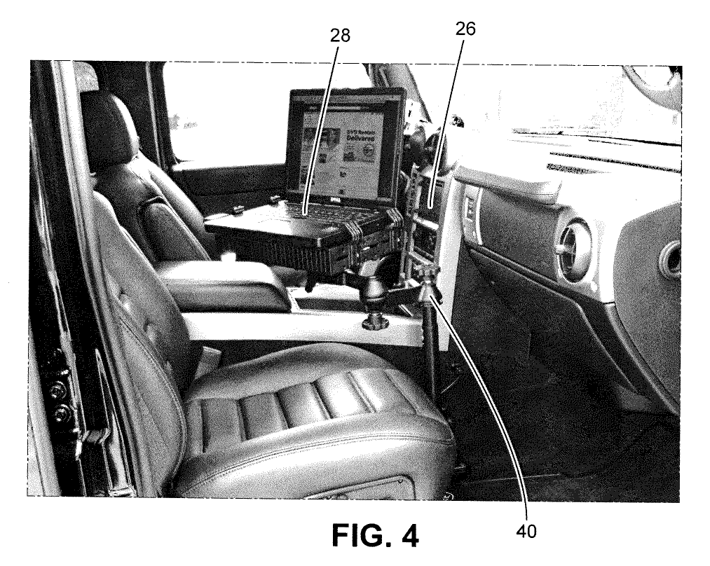

In the preferred embodiment, the vehicle further includes a ceiling mount display unit 24, and a navigation display 26 (see FIG. 4). The ceiling mount display unit 24 is situated near the front of the passenger compartment of the vehicle so as to provide viewing to nearly all passengers. Illustratively, the ceiling mount display unit 24 is larger than the headrest display unit 22. The ceiling display unit 24 is preferably of the type described in U.S. Pat. No. 6,292,236, the content of which is expressly incorporated herein by reference thereto. In an alternative embodiment each headrest display unit 24 is replaced by a ceiling display unit.

As shown in FIGS. 2 and 4, the vehicle includes a laptop computer 28 removably mounted on a computer stand 40 that is adjustably lockable both horizontally and vertically. The computer stand 40 is preferably of the type described in U.S. Pat. No. 6,315,252 the content of which is expressly incorporated herein by reference thereto. In an alternative embodiment, the computer can be mounted on the ceiling, similar to the ceiling mount display 24, with the human interface devices, such as, a keyboard and a mouse, configured to operate wirelessly.

In the preferred embodiment, the computer is arranged to access a searchable database containing information on the available real estate properties in the area. The database can also include other information pertaining to the area of interest, such as, school rating, crime rate, traffic commute, public transportation, shopping, restaurants, and entertainment. Generally, the database can be stored locally on a storage device in the computer, but is maintained up to date. In an alternative embodiment, the computer access the database over a wireless Internet connection. The computer also includes forms related to real estate rules, such as Security Deposit Agreement, Buyers Purchase Agreement, and Sellers Sales Agreement, which the purchaser can review and complete during travel. Preferably, the computer is wirelessly connected to an onboard printer, which can, for example, provide printouts of contract forms and documents.

Advantageously, the computer can access the Internet by a wireless link to facilitate purchase of products such as songs, movies, books and games. The wireless link also can provide the means for the user to access other Internet services such as e-mail, online banking, online gaming, and general Web search.

Referring to FIG. 2, some of the multimedia electronic component of the present invention can be installed in a multimedia compartment 30, which can be situated under the seat cushions of back passenger seats. The multimedia compartment 30 includes at least one game controller 32 providing means for a passenger to play a video game. Preferably, the vehicle includes three game controllers with two game controllers 32 preferably installed inside of the multimedia compartment 30, and a third game controller 32 situated outside of the multimedia compartment 30. Each game controller 32 can be selected from Microsoft's Xbox, Sony's play station 2, or Nintendo's GameCube. The multimedia compartment 30 further includes at least one satellite receiver 34 providing means for a passenger to watch satellite broadcast television on a display unit 22, and a video/audio distribution device 36, which allows distribution of a video/audio input source, such as, for example, satellite receiver 34, to one or more display units. Preferably the video distribution device 36 is AngleTrax video logic matrix processor AV44 providing logical mapping of up to four input source(s) to four output displays. The satellite receiver 34 is preferably DirecTV KVH receiver.

The multimedia compartment 30 also further includes at least one power converter 38 to convert the DC current from the vehicle to an AC current suitable for providing the necessary power for the multimedia components within the vehicle. As discussed above, the video/audio distribution device 36 has four video and audio outputs, the audio outputs of this device can be connected to a wireless audio transmitter 42 that can transmit up to four stereo audio outputs to a multi-source headphone 23. Preferably, the wireless audio transmitter 42 is Unwired Technology W4S-8212 WhiteFire infrared transmitter, and the multi-source headphone 23 is Unwired Technology W4H-229900 WhiteFire headphones.

In an alternative embodiment, the video game controller 32 can be any other popular video game controller, and the satellite receiver 34 can be any other form of television broadcast service. In this alternative embodiment, the multimedia compartment 30 can be situated elsewhere in the vehicle, such as, for example, in the trunk. In a further alternative embodiment, some or all of the equipments shown in FIG. 2 can be integrated into a single box to take advantage of reduced power consumption, form factor, heat dissipation, and wiring complexity. The multimedia vehicle entertainment is preferably of the type described in U.S. Patent Application No. 2004/0237111 the content of which is expressly incorporated herein by reference thereto.

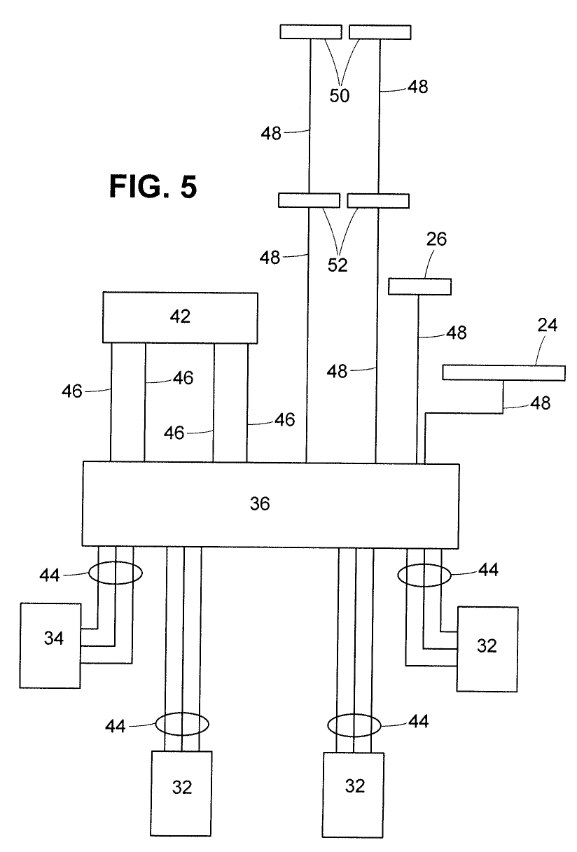

As shown in FIG. 5, the output of each game controller 32 can be connected to input of the video/audio distribution device 36 using a video/audio cable 44, so as to facilitate distribution of video/audio thereof. Similarly, the satellite receiver 34 can also be connected to the video/audio distribution device 36 using a video/audio cable 44. Preferably, the video/audio cable 44 is an RCA video/audio cable having two leads for stereo audio and one lead for video. The video/audio distribution device 36 can directly supply video portion of at least one program to the ceiling mount display unit 24, the navigation display 26, and second row headrest displays 52 each by a video cable 48. While, the second row headrest displays 52 can provide video feed to front row displays 50 also using a pair of video cables 48. The wireless audio transmitter 42 receives up to four stereo audio channels from the video/audio distribution device 36 using plurality of a stereo audio cables 46.

The preferred embodiment can further include other entertainment devices, such as, for example, XM satellite radio receiver, iPod, Sirius satellite radio receiver, and digital radio receiver. Moreover, the vehicle includes GPS capabilities that optimize the drive from one property to another, and the associated mapping function provide the potential buyer better understanding of the neighborhood. The GPS capabilities is preferably of the type described in U.S. Pat. No. 6,055,478 the content of which is expressly incorporated herein by reference.

The process of providing an EVSF experience requires staying current with and providing the hottest new vehicles, gadgets, music and other entertainments of that nature that can vary from year to year.

Another aspect of the invention relates to a survey form which is used to identify the customers likes and preferences prior to outfitting the vehicle for the real estate sales tour. The number of passengers anticipated, their particular types of entertainment, and even their preferences for beverage or snacks can be determined in advance so that the vehicle can be prepared with the appropriate items. Of course, the vehicle would be properly cleaned and outfitted in general after each use with a customer or potential real estate buyer, and prior to the use with a further customer.

It will be apparent to those skilled in the art that various modifications and variations can be made in the method of the present invention without departing from the spirit or scope of the invention. Thus, it is intended that the present invention include modifications and variations that are within the scope of the appended claims and their equivalents.

What is claimed is:

1. A method of enhancing personal reviews of available real estate which comprises providing a vehicle that includes individually selectable entertainment for passengers of the vehicle to provide diversion during travel between real estate locations to facilitate such reviews and enhance the personal real estate review experience.

2. The method of claim 1 which further comprises providing GPS capability to the vehicle to optimize travel between real estate locations.

3. The method of claim 1 wherein the individually selectable entertainment is provided at each passenger seat in the vehicle.

4. The method of claim 3, wherein the individually selectable entertainment is in the form of electronic entertainment, including one or more of a computer, a portable music player, or a video monitor for use by vehicle passengers.

5. The method of claim 4, which further comprises providing at least one computer in the vehicle and preferably one for each vehicle passenger.

6. The method of claim 5, wherein at least one computer in the vehicle includes a database stored on a storage device of the computer to provide information on available real estate properties.

7. The method of claim 5, wherein at least one computer in the vehicle includes a database stored on a storage device of the computer to provide forms related to real estate sales for completion by customer during travel.

8. The method of claim 5, which further comprises providing a wireless connection for at least one computer to the Internet network to facilitate sale of a product.

9. The method of claim 8, wherein the product includes songs and movies.

10. The method of claim 8, wherein the wireless connection facilitates e-mail service for review by a vehicle passenger during travel.

11. The method of claim 4, which further comprises providing at least one portable music player in the vehicle and preferably one for each vehicle passenger.

12. The method of claim 4, which further comprises providing at least one video monitor in the vehicle and preferably one for each vehicle passenger.

13. The method of claim 12, wherein the monitor is operatively associated with a computer or video broadcast to provide movies or television broadcast services.

14. The method of claim 12, wherein the monitor provides the capability for playing video games and the method further comprises providing video game controllers and related equipment for playing such games.

15. The method of claim 4, which further comprises providing at least one device that provides radio broadcast service in the vehicle and preferably one for each vehicle passenger.
